(19) United States
(12) Patent Application Publication
(10) Pub. No.: US 2008/0107075 A1
(43) Pub. Date: May 8, 2008

(54) SYSTEM AND METHOD TO FACILITATE PATH SELECTION IN A MULTIHOP NETWORK

(75) Inventors: Shyamal Ramachandran, Heathrow, FL (US); Keith J. Goldberg, Casselberry, FL (US)

Correspondence Address: MOTOROLA, INC, 1303 EAST ALGONQUIN ROAD, IL01/3RD, SCHAUMBURG, IL, 60196, US

(73) Assignee: MOTOROLA, INC., Plantation, FL (US)

(21) Appl. No.: 11/557,316

(22) Filed: Nov. 7, 2006

(51) Int. Cl. H04Q 7/00

(52) U.S. Cl. 370/331; 370/329

(57) ABSTRACT

A system and method to facilitate path selection in a multihop network includes receiving by a base station a path metric associated with each of a plurality of stations neighboring to a subscriber station; comparing each of the path metrics with a current path metric; and transmitting a path selection recommendation from the base station to the subscriber station when one of the compared path metrics is better than the current path metric.

### FIELD OF THE INVENTION

The present invention relates generally to wireless communication systems and more particularly to the operation of a communication network utilizing relay stations.

### BACKGROUND

An infrastructure-based wireless network typically includes a communication network with fixed and wired gateways. Many infrastructure-based wireless networks employ a mobile unit or host which communicates with a fixed base station that is coupled to a wired network. The mobile unit can move geographically while it is communicating over a wireless link to the base station. When the mobile unit moves out of range of one base station, it may connect or “handover” to a new base station and starts communicating with the wired network through the new base station.

In comparison to infrastructure-based wireless networks, such as cellular networks or satellite networks, ad hoc networks are self-forming networks which can operate in the absence of any fixed infrastructure, and in some cases the ad hoc network is formed entirely of mobile nodes. An ad hoc network typically includes a number of geographically-distributed, potentially mobile units, sometimes referred to as “nodes,” which are wirelessly connected to each other by one or more links (e.g., radio frequency communication channels). The nodes can communicate with each other over a wireless media without the support of an infrastructure-based or wired network. Links or connections between these nodes can change dynamically in an arbitrary manner as existing nodes move within the ad hoc network, as new nodes join or enter the ad hoc network, or as existing nodes leave or exit the ad hoc network. Because the topology of an ad hoc network can change significantly techniques are needed which can allow the ad hoc network to dynamically adjust to these changes. Due to the lack of a central controller, many network-controlling functions can be distributed among the nodes such that the nodes can self-organize and reconfigure in response to topology changes.

One characteristic of adhoc network nodes is that each node can directly communicate over a short range with nodes which are a single “hop” away. Such nodes are sometimes referred to as “neighbor nodes.” When a node transmits packets to a destination node and the nodes are separated by more than one hop (e.g., the distance between two nodes exceeds the radio transmission range of the nodes, or a physical barrier is present between the nodes), the packets can be relayed via intermediate nodes (“multi-hopping”) until the packets reach the destination node. In such situations, each intermediate node routes the packets (e.g., data and control information) to the next node along the route, until the packets reach their final destination

IEEE 802.16 is a point-to-multipoint (PMP) system with one hop links between a base station (BS) and a subscriber station (SS). Such network topologies severely stress link budgets at the cell boundaries and often render the subscribers at the cell boundaries incapable of communicating using the higher-order modulations that their radios can support. Pockets of poor-coverage areas are created where high data-rate communication is impossible. This in turn brings down the overall system capacity. While such coverage voids can be avoided by deploying BSs tightly, this drastically increases both the capital expenditure (CAPEX) and operational expenditure (OPEX) for the network deployment. A cheaper solution is to deploy relay stations (RSs) (also known as relays or repeaters) in the areas with poor coverage and repeat transmissions so that subscribers in the cell boundary can connect using high data rate links.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates an exemplary wireless communication network.

FIG. 2 illustrates an exemplary base station for use in the exemplary wireless communication network of FIG. 1 in accordance with some embodiments of the present invention.

FIG. 3 illustrates an exemplary relay station for use in the exemplary wireless communication network of FIG. 1 in accordance with some embodiments of the present invention.

FIG. 4 illustrates an exemplary subscriber station for use in the exemplary wireless communication network of FIG. 1 in accordance with some embodiments of the present invention.

FIG. 5 is an exemplary portion of the wireless communication network of FIG. 1 for implementing at least some embodiments of the present invention.

FIG. 6 is a flowchart illustrating an exemplary operation of the subscriber station of FIG. 4 in accordance with at least some embodiments of the present invention.

FIG. 7 is a flowchart illustrating an exemplary operation of the base station of FIG. 2 in accordance with at least some embodiments of the present invention.

FIG. 8 is an exemplary portion of the wireless communication network of FIG. 1 for implementing at least some embodiments of the present invention.

FIGS. 9 and 10 are flowcharts illustrating an exemplary operation of the wireless communication network of FIG. 1 in accordance with at least some embodiments of the present invention.

FIG. 11 is an exemplary portion of the wireless communication network of FIG. 1 for implementing at least some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to path selection in a multihop network. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of path selection in a multihop network described herein. The non-processor circuits may include, but are not limited to, a radio receiver, a radio transmitter, signal drivers, clock circuits, power source circuits, and user input devices. As such, these functions may be interpreted as steps of a method to perform path selection in a multihop network. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

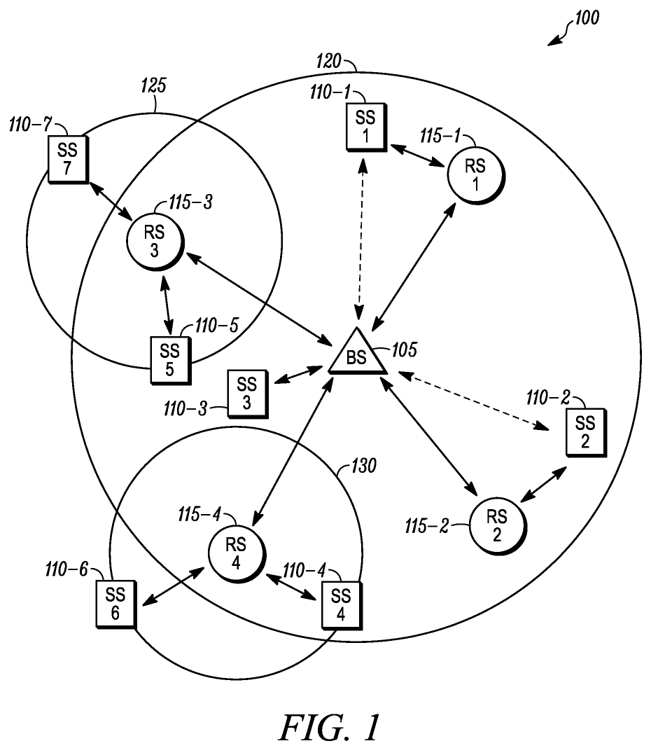

FIG. 1 illustrates an exemplary wireless communication network for use in the implementation of at least some embodiments of the present invention. FIG. 1 specifically illustrates an IEEE 802.16 network 100. As illustrated, the network 100 includes at least one base station 105 for communication with a plurality of subscriber stations 110-n. The exemplary network 100 further includes a plurality of relays 115-n (also known as relay stations or repeaters). The relays 115-n are deployed in the areas with poor coverage and repeat transmissions so that subscriber stations 110-n in a cell boundary can connect using high data rate links. In some cases relays 115-n may also serve subscriber stations 110-n that are out of the coverage range of the base station 105. In some networks, the relays 115-n are simpler versions of the base station 105, in that they do not manage connections, but only assist in relaying data. Alternatively, the relays 115-n can be at least as complex as the base station 105.

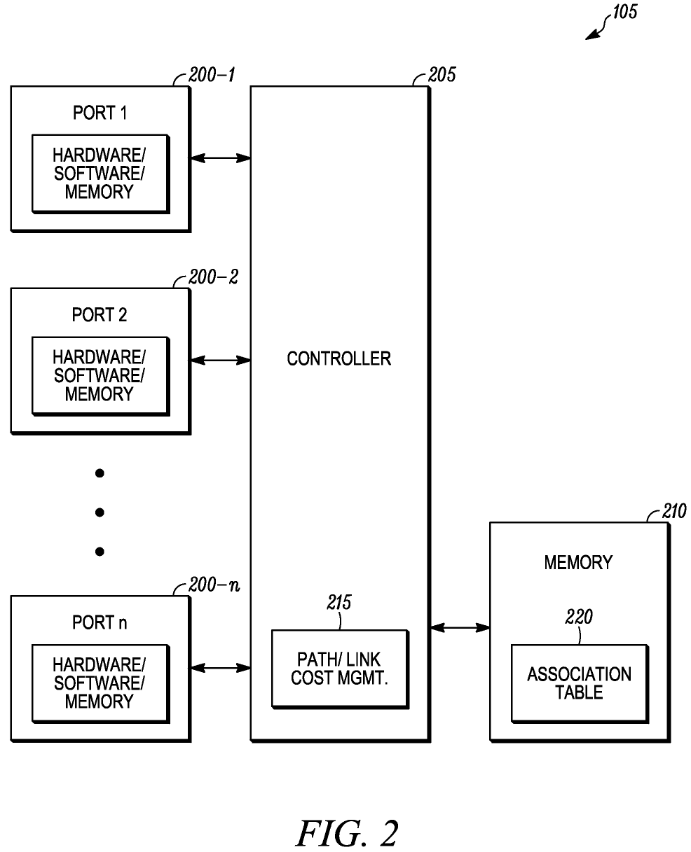

FIG. 2 illustrates an exemplary base station 105 in accordance with some embodiments of the present invention. As illustrated, the base station 105 comprises a plurality of ports 200-n, a controller 205, and a memory 210.

Each port 200-n provides an endpoint or “channel” for network communications by the base station 105. Each port 200-n may be designated for use as, for example, an IEEE 802.16 port or a backhaul port or an alternate backhaul port. For example, the base station 105 can communicate with one or more relay stations and/or one or more subscriber stations within an 802.16 network using an IEEE 802.16 port. An IEEE 802.16 port, for example, can be used to transmit and receive both data and management information.

A backhaul port similarly can provide an endpoint or channel for backhaul communications by the base station 105. For example, the base station 105 can communicate with one or more other base stations using the backhaul, which can be wired or wireless, via the backhaul port.

Each of the ports 200-n are coupled to the controller 205 for operation of the base station 105. Each of the ports employs conventional demodulation and modulation techniques for receiving and transmitting communication signals respectively, such as packetized signals, to and from the base station 105 under the control of the controller 205. The packetized data signals can include, for example, voice, data or multimedia information, and packetized control signals, including node update information.

The controller 205 includes a path/link cost management block 215, which will be described in detail herein. It will be appreciated by those of ordinary skill in the art that the path/link cost management block 215 and the parameters utilized therein can be hard coded or programmed into the base station 105 during manufacturing, can be programmed over-the-air upon customer subscription, or can be a downloadable application. It will be appreciated that other programming methods can be utilized for programming the path/link cost management block 156 into the base station 105. It will be further appreciated by one of ordinary skill in the art that path/link cost management block 215 can be hardware circuitry within the base station. In accordance with the present invention, the path/link cost management block 215 can be contained within the controller 205 as illustrated, or alternatively can be an individual block operatively coupled to the controller 205 (not shown).

To perform the necessary functions of the base station 105, the controller 205 is coupled to the memory 210, which preferably includes a random access memory (RAM), a read-only memory (ROM), an electrically erasable programmable read-only memory (EEPROM), and flash memory.

The memory 210 includes storage locations for the storage of an association table 220. The association table 220, in accordance with the present invention, stores a listing of all subscriber stations under the base station's domain along with the end-to-end path metrics to each of the subscriber stations under its domain. For subscriber stations directly coupled to the base station 105, the base station uses the path/link cost management block 215 to transform one hop RSSI and/or SNR measurements into a link metric and stores the result in the association table 220. For subscriber stations coupled to the base station 105 via one or more relay stations 115-n, the base station 105 learns the path metric with the help of the subscriber station's access relay station (this is the relay station to which the subscriber station is directly attached). Each relay station periodically monitors its link quality (and as a result its link metric) to the next-hop relay station towards the base station 105. Each relay station then adds this link metric to the path metric advertised by the upstream relay station to determine the end-to-end path metric to the base station 105. Each relay station also informs the base station 105 of this value. Therefore the base station 105 is periodically informed of the path metric between the base station and the relay station. The path/link cost management block 215 of the base station 105 can then determine the link metric to the subscriber station and store it within the association table 220.

It will be appreciated by those of ordinary skill in the art that the memory 210 can be integrated within the base station 105, or alternatively, can be at least partially contained within an external memory such as a memory storage device. The memory storage device, for example, can be a subscriber identification module (SIM) card.

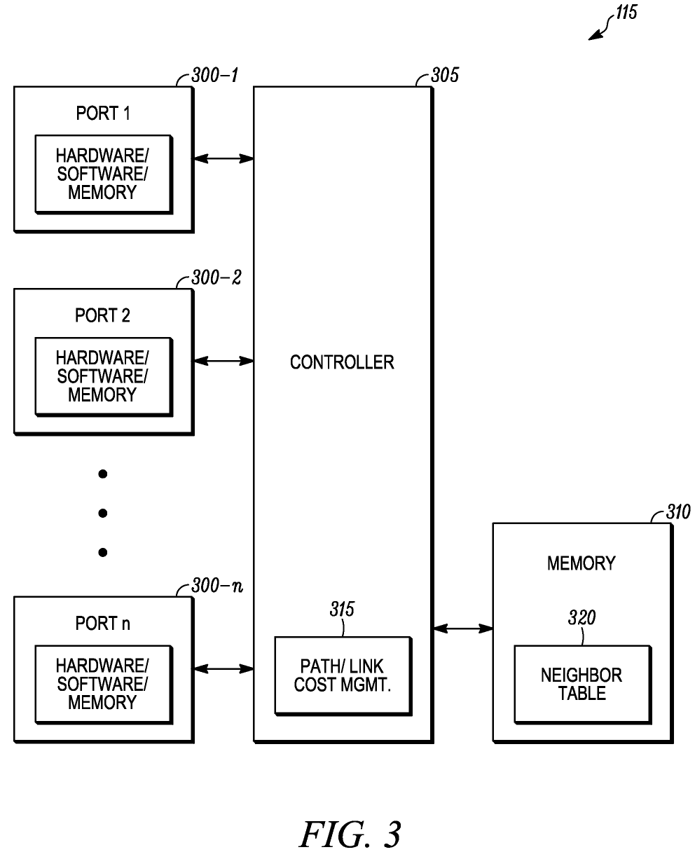

FIG. 3 illustrates an exemplary relay station 115 in accordance with some embodiments of the present invention. As illustrated, the relay station 115 comprises a plurality of ports 300-n. Each port 300-n may be designated for use as, for example, an IEEE 802.16 port or a backhaul port or an alternate backhaul port. For example, the plurality of ports 300-n can include an IEEE 802.16 port, which is used to communicate with one or more base stations, one or more relay stations and/or one or more subscriber stations. The relay station 115 further comprises a controller 305 and a memory 310.

An IEEE 802.16 port, for example, provides an endpoint or “channel” for 802.16 network communications by the relay station 115. For example, the relay station 115 can communicate with one or more base stations and/or one or more relay stations and/or one or more subscriber stations within an 802.16 network using the IEEE 802.16 port. An IEEE 802.16 port, for example, can be used to transmit and receive both data and management information.

Each of the ports 300-n are coupled to the controller 305 for operation of the relay station 115. Each of the ports employs conventional demodulation and modulation techniques for receiving and transmitting communication signals respectively, such as packetized signals, to and from the relay station 115 under the control of the controller 305. The packetized data signals can include, for example, voice, data or multimedia information, and packetized control signals, including node update information.

In accordance with the present invention, the controller 305 includes a path/link cost management block 315. It will be appreciated by those of ordinary skill in the art that the path/link cost management block 315 and the parameters utilized therein can be hard coded or programmed into the relay station 115 during manufacturing, can be programmed over-the-air upon customer subscription, or can be a downloadable application. It will be appreciated that other programming methods can be utilized for programming the path/link cost management block 315 into the relay station 115. It will be further appreciated by one of ordinary skill in the art that the path/link cost management block 315 can be hardware circuitry within the relay station 115. In accordance with the present invention, the path/link cost management block 315 can be contained within the controller 305 as illustrated, or alternatively can be individual blocks operatively coupled to the controller 305 (not shown).

To perform the necessary functions of the relay station 115, the controller 305, and/or the path/link cost management block 315 are each coupled to the memory 310, which preferably includes a random access memory (RAM), a read-only memory (ROM), an electrically erasable programmable read-only memory (EEPROM), and flash memory. The memory 310 includes storage locations for the storage of a neighbor table 320.

In operation, the path/link cost management block 315 periodically monitors the link quality (and as a result its link metric) to the next-hop relay station towards an associated base station. The path/link cost management block 315 then adds this link metric to the path metric advertised by the upstream relay station as stored within the neighbor table 320 to determine the end-to-end path metric to the base station. The relay station 115 can also inform the base station of this value.

In one embodiment, where the relay station 115 is an access relay station for an associated subscriber station, the path/link cost management block 315 of the access relay station 115 makes measurements on the associated subscriber station 110 and determines the link metric on the access link. It adds this value to the aggregate path metric between itself and an associated base station to determine the path metric between the subscriber station and the base station. The relay station 115 can also inform the base station of this value.

It will be appreciated by those of ordinary skill in the art that the memory 310 can be integrated within the relay station 115, or alternatively, can be at least partially contained within an external memory such as a memory storage device. The memory storage device, for example, can be a subscriber identification module (SIM) card.

In typical systems such as the network 100, IEEE 802.16 base stations (BSs) do not forward traffic to other base stations on the IEEE 802.16 air interface. Further, IEEE 802.16 Relays (RSs) can forward traffic to base stations, relay stations, or subscriber stations (SSs). As previously mentioned, the relay stations are themselves managed/controlled by at least one of the base stations. Further relay stations can be fixed, nomadic or mobile.

As illustrated in FIG. 1, the relay stations 115-n of the network 100 can provide communication coverage outside the base station coverage area 120. For example, a relay station 3 115-3 provides a coverage area 125 and a relay station 4 115-4 provides a coverage area 130 which include communication coverage outside of a coverage area 120 of the base station 105. Thus communication by relay station 3 115-3 can include communication for subscriber station 7 110-7; and communication by relay station 4 115-4 can include communication for subscriber station 6 110-6, which otherwise would not be possible directly to the base station 105. Since subscriber station 6 110-6 and subscriber station 7 110-7 cannot be controlled by the base station 105 directly, they are entirely controlled by the relay stations 115-4 and 115-3 respectively, or by the base station 105 through the relay stations 115-4 and 115-3 respectively.

In summary, the relay stations (RS) introduced in an IEEE 802.16 system, can provide coverage and capacity gains by extending the base station's (BS) range and permitting subscriber stations (SS) to multihop to the BS.

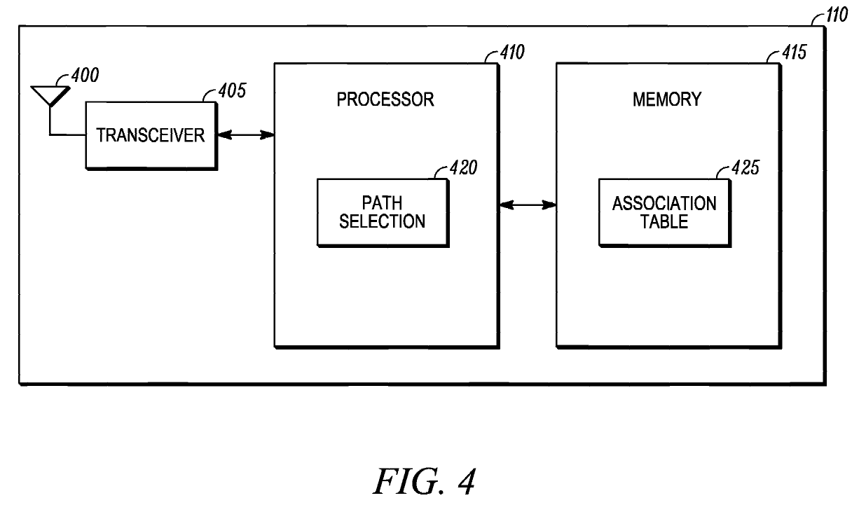

FIG. 4 is an electronic block diagram of one embodiment of a subscriber station 110 in accordance with the present invention. As illustrated, the subscriber station 110 includes an antenna 400, a transceiver (or modem) 405, a processor 410, and a memory 415.

The antenna 400 intercepts transmitted signals from one or more base stations 105, one or more relay stations 115, and/or one or more subscriber stations 110 within the network 100 and transmits signals to the one or more base stations 105, one or more relay stations 115, and/or one or more subscriber stations 110 within the network 100. The antenna 400 is coupled to the transceiver 405, which employs conventional demodulation techniques for receiving and transmitting communication signals, such as packetized signals, to and from the subscriber station 110 under the control of the processor 410. The packetized data signals can include, for example, voice, data or multimedia information, and packetized control signals, including node update information. When the transceiver 405 receives a command from the processor 410, the transceiver 405 sends a signal via the antenna 400 to one or more devices within the network 100. For example, the subscriber station 110 can communicate with one or more base stations and/or one or more relay stations and/or one or more subscriber stations within an 802.16 network by the antenna 400 and the transceiver 405 using IEEE 802.16, for example, to transmit and receive both data and management information.

In an alternative embodiment (not shown), the subscriber station 110 includes a receive antenna and a receiver for receiving signals from the network 100 and a transmit antenna and a transmitter for transmitting signals to the network 100. It will be appreciated by one of ordinary skill in the art that other similar electronic block diagrams of the same or alternate type can be utilized for the subscriber station 110.

Coupled to the transceiver 405, is the processor 410 utilizing conventional signal-processing techniques for processing received messages. It will be appreciated by one of ordinary skill in the art that additional processors can be utilized as required to handle the processing requirements of the processor 410.

In accordance with the present invention, the processor 410 includes a path selection block 420 for selecting an optimum path for communication between the subscriber station 110 and at least one base station 105, relay station 115, or subscriber station 110. It will be appreciated by those of ordinary skill in the art that the path selection block 420 can be hard coded or programmed into the subscriber station 110 during manufacturing, can be programmed over-the-air upon customer subscription, or can be a downloadable application. It will be appreciated that other programming methods can be utilized for programming the path selection block 420 into the subscriber station 110. It will be further appreciated by one of ordinary skill in the art that the path selection block 420 can be hardware circuitry within the subscriber station 110. In accordance with the present invention, the path selection block 420 can be contained within the processor 410 as illustrated, or alternatively can be an individual block operatively coupled to the processor 410 (not shown). Further operation of the path selection block 420 will be described subsequently herein.

To perform the necessary functions of the subscriber station 110, the processor 410 is coupled to the memory 415, which preferably includes a random access memory (RAM), a read-only memory (ROM), an electrically erasable programmable read-only memory (EEPROM), and flash memory. The memory 415, in accordance with the present invention, includes storage locations for the storage of an association table 425, to be described subsequently herein.

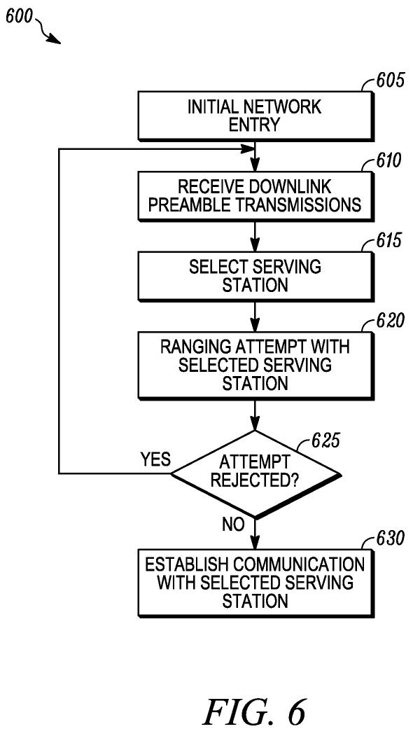

In operation, when the subscriber station 110 initially joins a network, the path selection block 420 uses one or more link metrics associated with one or more neighbor stations stored in the association table 425 to determine a serving station in which to associate with as will be described in further detail in FIG. 6 herein below.

It will be appreciated by those of ordinary skill in the art that the memory 415 can be integrated within the subscriber station 110, or alternatively, can be at least partially contained within an external memory such as a memory storage device. The memory storage device, for example, can be a subscriber identification module (SIM) card.

In a one-hop network, (i.e. a one-hop IEEE 802.16 network) while entering the network, it is sufficient for a subscriber station (SS) to measure the signal strength and/or the signal-to-noise ratio (SNR) of signals received from one or more base stations (BS). The subscriber station then compares the measured parameters from each base station in order to select the best base station to associate with.

In a multihop network (i.e. a multihop IEEE 802.16 network) that employs relay stations (RS) for the purpose of coverage extension or capacity improvement, it is important for the subscriber stations (SS) to consider an end-to-end path metric before associating with a base station (either directly or through one or more relay stations). The end-to-end path metric is typically the sum total of the individual link metrics of the access link (BS-SS or RS-SS) and all of the relay links (BS-RS or RS-RS), that occur on an end to end path between a subscriber station and a base station. It will be appreciated by those of ordinary skill in the art that the end-to-end path metric can also be any other function of the individual link metrics of the path, and need not always be additive. A one-hop signal strength or SNR measure on the access link alone will not convey to the subscriber the suitability of an access node.

It will be appreciated by those of ordinary skill in the art that it is desirable for all relay stations to appear to be just like a base station to each of the subscriber stations within a network. Further, it is desirable to utilize existing subscriber stations with no changes to operate in a multihop network. Given these constraints, the present invention provides a method to facilitate intelligent path selection for the subscriber station, by the network. By providing a method that is transparent to the subscriber station, existing handoff messages (i.e. existing IEEE 802.16e handoff messages) can be reused.

It will be appreciated by those of ordinary skill in the art that the target base station to which a subscriber station hands off to is ultimately the subscriber station's decision. The serving base station might recommend other base stations, and might even force the subscriber station to handoff, but the target is always the subscriber station's choice. The subscriber station can choose any of the neighbors it is aware of as a suitable handoff target. Since the subscriber stations are not aware of the presence of a multihop network, it is very likely that a subscriber station makes a wrong decision based on the one-hop downlink measurements.

The present invention provides a method to minimize such wrong decisions by the subscriber station by eliminating one or more relay stations from a subscriber station's consideration, if the relay station(s) are determined to be unsuitable to handle the subscriber station.

Specifically, the present invention provides a resolution for the following existing network problems:
a. When a subscriber station enters a network, it bases its selection of the serving base station on one-hop downlink (DL) SNR or RSSI. This is insufficient for a multihop network and can even be detrimental to network performance.
b. When a subscriber station hands off from a serving base station to other neighbors, its neighbor selection criteria typically involves selecting the strongest one-hop DL. One hop DL measurements are insufficient. The network beneficially should assist the subscriber station in selecting the more suitable neighbor base stations over the less suitable ones.

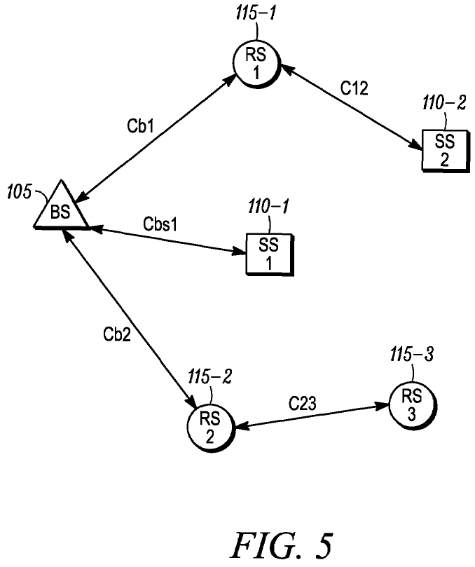

FIG. 5 is an exemplary portion of a multi-hop network for implementing at least some embodiments of the present invention. As discussed previously herein, a base station maintains the end-to-end path metrics to all the subscriber stations under its domain. For subscriber stations directly coupled to the base station, the base station learns the link metrics by means of transforming one hop RSSI or SNR measurements into a link metric. For example, in FIG. 5, the base station 105 determines and records the link metric for SS1 110-1 to be Cbs1. This is also the total path metric to SS1 110-1 since it is only one hop from the base station 105.

For subscriber stations 110-n attached via one or more relay stations 115-n, the base station 105 learns the path metric with the help of each subscriber station's access relay station. As discussed previously herein, each relay station 115-n periodically monitors its link quality (and as a result its link metric) to the next-hop relay station towards the base station 105. Each relay station 115-n then adds this link metric to the path metric advertised by the upstream relay station to determine the end-to-end path metric to the base station 105. Each relay station 115-n also informs the base station 105 of this value. Therefore the base station 105 is periodically informed of the path metric between the base station 105 and the relay station 115-n. For example, in FIG. 5, RS2 115-2 determines the cost between itself and the base station 105 to be Cb2. It informs the base station 105 of this value as the path metric between the base station 105 and itself. It also informs RS3 115-3 of this cost, Cb2. RS3 115-3 measures the link between itself and RS2 115-2 to determine the link cost C23. RS3 115-3 then reports the path metric between itself and the base station 105 as (Cb3=Cb2+C23). Note that this additive path metric is just an example used here (and throughout this invention description) for simplicity. The path metric could be any function of (Cb2,C23).

As discussed previously herein, the access relay station 115-n makes measurements on the associated subscriber station 110-n and determines the link metric on the access link. It adds this value to the aggregate path metric between itself and the base station 105 to determine the path metric between the subscriber station 110-n and the base station 105. For example, in FIG. 5, RS1 115-1 determines the link metric between itself and SS2 110-2 to be C12. It adds this to its own cost to the base station 105, Cb1, and reports to the base station 105 a path metric of (C12+Cb1). RS1 115-1 informs the base station 105 of this subscriber station path metric, either periodically or when the subscriber station 110-2 indicates interest in a handoff.

Effectively, when a subscriber station is associated with a base station directly or through one or more relay stations, the base station is aware of the end-to-end path metric between the base station and the subscriber station. This value is used by the base station to customize the neighbor advertisement for the subscriber station.

### Initial Subscriber Station Network Entry

FIG. 6 is a flowchart illustrating the operation 600 of a subscriber station when it initially enters a network in accordance with at least some embodiments of the present invention. Specifically, the operation 600 can be implemented within the path selection block 420 of the subscriber station 110 of FIG. 4.

As illustrated in FIG. 6, the operation begins with Step 605 with the subscriber station powering up in a network for the first time (i.e. not a handoff). Next, in Step 610, the subscriber station looks for downlink preamble transmissions from base stations and relay stations (which look like base stations to the subscriber station, for example, per an IEEE 802.16j backward compatibility requirement). After receiving one or more downlink preamble transmissions, in Step 615 the subscriber station selects the base station or relay station with the strongest downlink preamble as its preferred serving station.

Next, in Step 620, the subscriber station attempts to range with the selected serving station device by transmitting a ranging sequence (i.e. a Code division multiple access (CDMA) ranging sequence) on the uplink during an initial ranging interval scheduled by the chosen serving station. The base station or relay station receiving an initial ranging code should return the required correction values and request the subscriber station to “continue” in a dedicated slot allotted to this subscriber station.

In accordance with the present invention, when the subscriber station sends a ranging request (RNG-REQ) message on the uplink, the serving station should consider the “serving base station identification (BS ID)” field to determine if this subscriber station is entering the network for the first time or is handing off. If the subscriber station does not have a valid BS ID value in the RNG-REQ, the serving station assumes that the subscriber station is a new entrant to the network. It then converts the uplink measurements made on the ranging code into the expected link metric to the subscriber station. If the serving station is a base station, this link metric is also the end-to-end path metric. If the serving station is a relay station, the link metric value is combined with its path metric to its base station. If the relay station's end-to-end path metric is below a permissible threshold, the serving station rejects the subscriber station's attempt to access the network through it. The preferred mechanism to achieve this is that the serving station sends a ranging response (RNG-RSP) message with ranging status of “abort”. In Step 625 of FIG. 6, when the ranging attempt is rejected, the operation returns to Step 610 in which the subscriber station rescans the downlink and selects a different serving station.

When, at Step 625, the attempt is not rejected (i.e. accepted), the operation continues to Step 630 in which communication is established between the selected serving station and the subscriber station.

Handoff Optimization

The present invention provides a number of improvements to assist a subscriber station in selecting the best path during a handoff as described herein below.

### Customized Neighbor List

In the present day cellular networks each base station includes either all known base stations or all neighboring base stations in the list of handoff options to all subscriber stations in its cell.

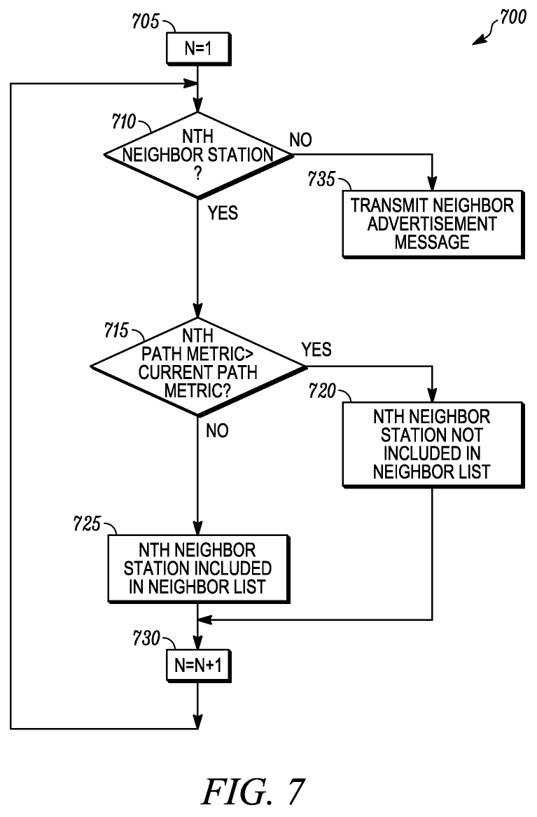

FIG. 7 is a flowchart illustrating an exemplary operation 700 of a base station in accordance with at least some embodiments of the present invention. Specifically, FIG. 7 illustrates the creation by a base station in a multihop IEEE 802.16j network of a customized neighbor advertisement message (MOB NBR-ADV) to be transmitted to each of the subscriber stations associated to it either directly or through one or more relay stations.

As illustrated in FIG. 7, the operation 700 begins with Step 705 in which a parameter is set to N=1. Next, in Step 710, the base station checks for an Nth neighbor station. It will be appreciated that the Nth neighbor station can be a base station or a relay station. When a Nth neighbor station exists, the operation continues to Step 715 in which the path metric to the subscriber station for the Nth neighbor station is compared to a current path metric to the subscriber station. The path metric, for example, can be a path cost. In Step 720, when the path metric to the Nth neighbor station is more than the current path metric to the subscriber station, the Nth neighbor station is not included in the list of neighbors included in the MOB_NBR-ADV message sent to the subscriber station from the base station. In Step 725, when the path metric to the Nth neighbor station is less than the current path metric to the subscriber station, the Nth neighbor station is included in the list of neighbors included in the MOB_NBR-ADV message sent to the subscriber station from the base station. In other words, the criteria used to include a base station or a relay station in the list of neighbors included in the MOB_NBR-ADV message is the path cost (metric) between the base station and the particular neighbor. After Steps 720 and 725, the operation continues to Step 730 in which the parameter is incremented to N=N+1. The operation then cycles back to Step 710 to check for an Nth neighbor station.

When an Nth neighbor station does not exist, the operation continues to Step 735 in which the base station sends a customized neighbor advertisement message (MOB_NBR-ADV) including all the neighbor stations identified to be included in the neighbor list to the particular subscriber station. This MOB_NBR-ADV message is, for example, sent on the primary management connection identification (CID) of the subscriber station. For example, in the network shown in FIG. 5, the base station 105 may include RS1 115-1 and RS2 115-2 as neighbors to SS1 110-1, and eliminate RS3 115-3 when Cbs1<Cb2+C23.

Generally, the operation of FIG. 7 will eliminate relay stations that might be unsuitable candidates because they might be more hops away from the base station than the subscriber station's current hop count, they might have one or more weak RF links on their path to the base station, or they might be overly congested and unable to handle more traffic. In one embodiment, this list will not eliminate any base stations as possible neighbors.

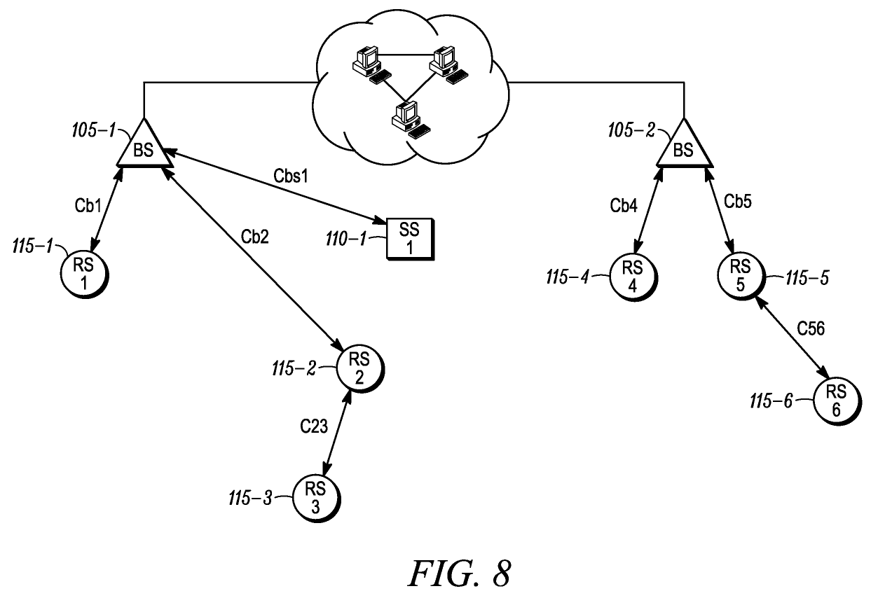

In the example shown in FIG. 8, BS1 105-1 includes RS2 115-2 as a neighbor for SS1 110-1. BS2 105-2 periodically reports the path metric of each of its relay stations to BS1 105-1, and all other neighboring base stations. Preferably, the base stations are configured with information about neighboring base stations as is known in the art. As a result BS1 105-1 includes RS4 115-4 as a neighbor to SS1 110-1. Assuming RS2 115-2 and RS4 115-4 are the only two relay stations with a path metric lower than Cbs1 (the path metric from BS1 105-1 directly to SS1 110-1), BS1 105-1 includes RS2 115-2, RS4 115-4 and BS2 105-2 in the MOB_NBR-ADV that it sends on SS1's basic management CID.

Note that if BS1 105-1 does not have the path metrics to one or more of the relay stations associated to the BS2 105-2, it preferably includes them in the neighbor list of all its subscriber stations. The path metrics to these neighboring devices can be determined during the handoff process as discussed herein below.

### Multihop Handoff

A base station maintains three operator-tunable parameters to use in the multihop handoff process; Handoff Metric Offset (HO_METRIC_OFFSET), Handoff Metric Hysteresis (HO_METRIC HYS), and Threshold Number of Hops (N_HOPS). Their use will be discussed herein below.

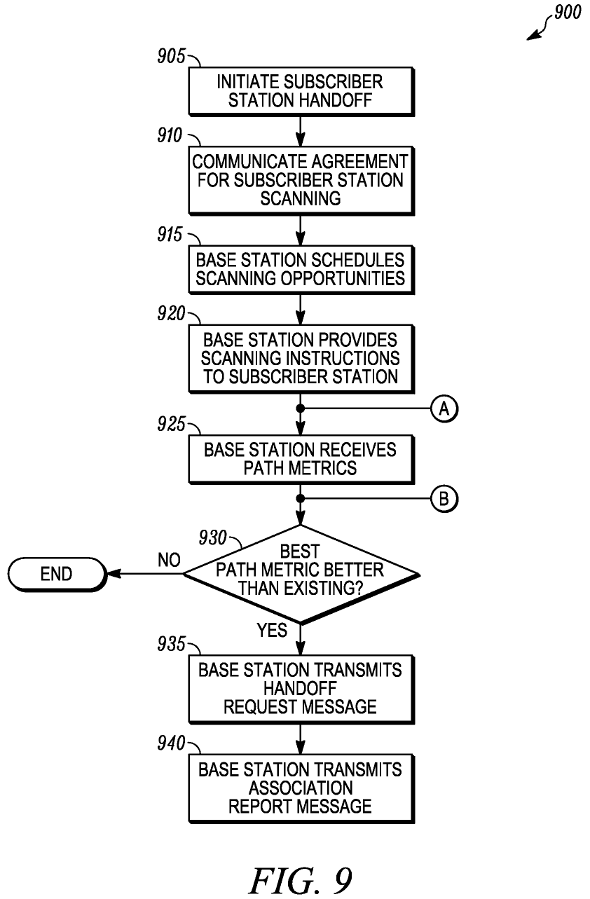

FIG. 9 is a flowchart illustrating an exemplary procedure 900 for multihop handoff by a subscriber station in accordance with at least some embodiments of the present invention. As illustrated, the operation begins with Step 905 in which a subscriber station handoff is initiated. In accordance with the present invention, the handoff can be base station initiated or can alternatively be subscriber station initiated. For example, when a base station determines that the end-to-end path metric to a subscriber station has dropped below the path metric to the best neighbor by a certain threshold value HO_METRIC_OFFSET, the base station initiates the process of subscriber station handoff. In another example, a subscriber station can determine a need to handoff (based on its one-hop link characteristics, since it is a legacy 802.16 device) and request permission from the base station to scan its neighbors using the Mobile Scan Request message (MOB_SCN-REQ).

Next, in Step 910, communication between the base station and the subscriber station establishes agreement for the subscriber station to scan its neighbors. For example, when the handoff is base station initiated, the base station requests the subscriber station to scan for its neighbors using the Mobile Scan Response (MOB_SCN-RSP). Alternatively, when the handoff is subscriber station initiated, the base station allows scanning by the subscriber station using MOB_SCN-RSP.

Next, in Step 915, the base station schedules scanning opportunities for the subscriber stations by ordering its neighbors by ascending path cost. Should scheduling constraints prevent the ability to include all neighbors in the promising neighbor list, the best options, based on path metric, will be scheduled first.

Next, in Step 920, the base station provides the subscriber station with scanning instructions. For example, when a base station instructs a subscriber station to scan for another base station (or relay station) either in response to a scan request message (MOB_SCN-REQ), or in an unsolicited fashion, it specifies that the relay stations associated with other base stations be scanned with association “with network assistance”. This enables the subscriber station to dwell in the target station's channel for a shorter period, and the handoff outcome is conveyed over the backhaul via the serving base station. In another example, when a base station instructs a subscriber station to scan for other relay stations associated with itself, it specifies that for relay stations associated with itself and greater that N_HOPS away, the subscriber station should scan with association “with network assistance”. The base station ideally uses N_HOPS to be equal to the hop count of the subscriber station's current access relay station (if the subscriber station is in fact talking to the base station through a relay station).

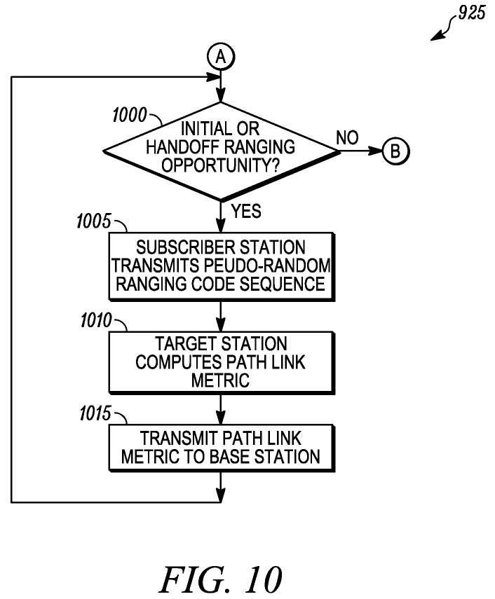

Next, in Step 925, the base station receives path metrics from neighboring relay stations and base stations. More detail of Step 925 is illustrated in FIG. 10. As illustrated in FIG. 10, the operation of Step 925 begins with node A of FIG. 9 and in FIG. 10, Step 1000 the subscriber station attempts to associate with a target base station or relay station by scanning for the downlink MAP message (DL-MAP) to look for an initial or handoff ranging opportunity. When an initial or handoff ranging opportunity is identified, in Step 1005, the subscriber station transmits a CDMA pseudo-random ranging code sequence. Next, in Step 1010, the target base station or relay station then measures the one hop link quality between the subscriber station and itself based on the RSSI or CINR measure on the code sequence. This link quality may also be translated to the one hop path cost. If the target station is a relay station, it also computes the end-to-end path metric from this subscriber station to its serving base station. Next, in Step 1015, this value is reported to the subscriber station's serving base station. The operation then cycles back to Step 1000 and the subscriber station looks for other ranging opportunities. When no ranging opportunities are identified, the operation returns to node B of FIG. 9.

Referring back to FIG. 9, at Step 930, the serving base station compares the subscriber station's current path metric and the expected path metric reported by one or more target stations and decide if handoff (HO) is required. When the best expected path metric reported is not better than the existing path metric by HO_METRIC_HYS, the operation ends. When the best expected path metric reported is better than the existing path metric by HO_METRIC HYS, the operation continues to Step 935, in which the serving base station will issue a Mobile Base Station Handoff Request message (MOB_BSHO-REQ) with the selected best target station in the list.

As noted before the subscriber station could still choose to ignore the base station's recommendation and attempt to handoff to any target station of its choosing. The base station attempts to ensure that the selection made by it is honored as far as possible. In addition to sending the MOB_BSHO-REQ, the base station also optionally sends, in Step 940, an association report message, Mobile Association Result Report message (MOB_ASC-REP), for undesirable stations with the ranging status as “abort”. This will prevent the subscriber station from handing off to stations that have been marked undesirable by the base station based on multihop end-to-end metrics, but still seem attractive to the subscriber station based on its one-hop measurements. It will be appreciated by those of ordinary skill in the art that Step 940 can occur before, after, or at the same time as Step 935, in accordance with the present invention.

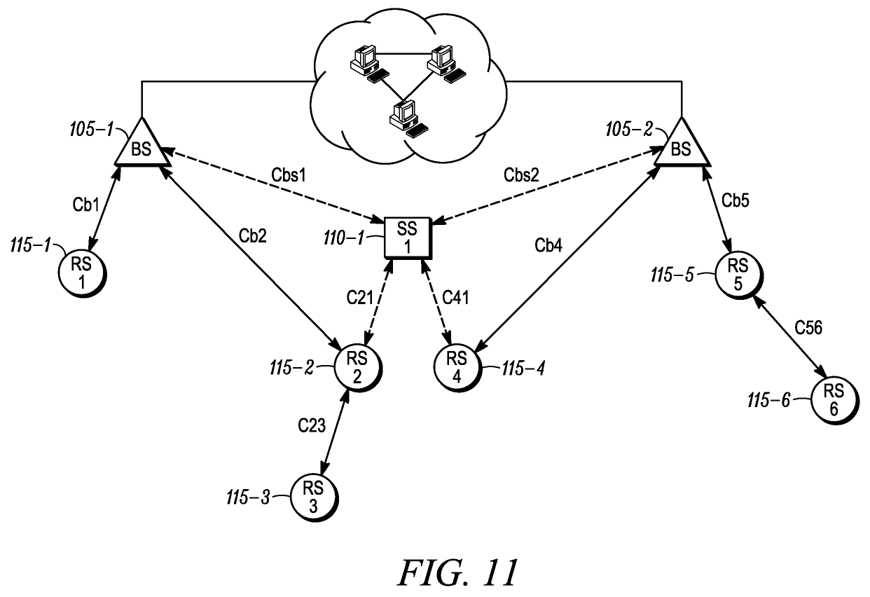

FIG. 11 is an exemplary network implementation of the handoff procedure described herein for FIGS. 9 and 10. As illustrated in FIG. 11, BS1 105-1 is the serving base station for SS1 110-1. Assuming that SS1 110-1 is currently directly associated with BS1 105-1, its path metric is Cbs1 (which is below HO_METRIC_OFFSET). Also assume that the neighbor list for SS1 110-1 has been pruned to only include RS2 115-2, BS2 105-2, and RS4 115-4.

In accordance with the present invention, BS1 105-1 instructs SS1 110-1 to scan BS2 105-2, RS2 115-2, and RS4 115-4, in that order, assuming Cb4 is greater than Cb2. BS1 105-1 will further instruct SS1 110-1 to scan with network assistance for all three likely handoff targets.

SS 1 110-1 performs initial or handoff ranging with each of the three candidates one after another. They each measure the SNR (or RSSI) of the CDMA code transmitted by the subscriber station and convert the measurements into the link cost. For example, BS2 105-2 computes a link cost of Cbs2. RS2 115-2 and RS4 115-4 compute the link costs of C21 and C41 respectively. They each report the total end-to-end path costs to BS1 105-1. BS2 105-2 reports Cbs2, RS2 115-2 reports (Cb2+C21), RS4 115-4 reports (Cb4+C41).

BS1 105-1 selects the best reported path cost that is better than Cbs1 by HO_METRIC_HYS. Assume that Cbs2<(Cbs1−HO_METRIC HYS). In this case BS1 105-1 recommends BS2 105-2 as the best handoff candidate in its MOB_BSHO_REQ sent to SS1 110-1. It further discourages SS1 110-1 from selecting RS2 115-2 or RS4 115-4 by sending MOB_ASC-REP with “abort” as the ranging status from RS2 115-2 and RS4 115-4.

The present invention as described herein provides a mechanism of assisting a subscriber station in selecting the best access node (base station or relay station) to access the network. Although the subscriber station has only a one-hop view of the network, the base station associated with the subscriber station make recommendations based on a multihop metric. The base station further ensures that the subscriber station does not select the path though a wrong neighbor.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A method to facilitate path selection in a multihop network comprising:
transmitting a ranging request message including a ranging code from a subscriber station to a serving station to access the multihop network through the serving station;
converting by the serving station one or more uplink measurements made on the ranging code into a path link metric to the subscriber station;
rejecting by the serving station the ranging request when the path link metric is below a threshold value; and
providing access to the multihop network for the subscriber station through the serving station when the path link metric is above the threshold value.

2. A method to facilitate path selection in a multihop network as claimed in claim 1, further comprising:
scanning a downlink by the subscriber station and selecting a different serving station; and
repeating the converting, rejecting, and accepting steps by the different serving station.

3. A method to facilitate path selection in a multihop network as claimed in claim 1, wherein the serving station comprises a base station, and further wherein the path link metric comprises an end-to-end path metric.

4. A method to facilitate path selection in a multihop network as claimed in claim 1, wherein the serving station comprises a relay station, and further wherein the path link metric comprises a link metric value combined with a path metric to an associated base station.

5. A method to facilitate path selection in a multihop network as claimed in claim 1, wherein the rejecting step comprises the serving station transmitting a ranging response message with ranging status of “abort” to the subscriber station.

6. A method to facilitate path selection in a multihop network as claimed in claim 1, further comprising prior to the transmitting the ranging request message step:
scanning by the subscriber station for one or more downlink preamble transmissions from one or more stations;
receiving one or more downlink preamble transmissions from the one or more stations; and
selecting the serving station with the strongest downlink preamble.

7. A method of operation of a base station to facilitate path selection in a multihop network for a subscriber station, the method comprising:
comparing a path metric for each of a plurality of neighbor stations with a current path metric for the subscriber station;
including a neighbor station within a list of neighbors when the path metric for the neighbor station is less than the current path metric; and
transmitting a neighbor advertisement message from the base station to the subscriber station including the list of neighbors.

8. A method of operation of a base station to facilitate path selection in a multihop network for a subscriber station as claimed in claim 7, wherein the neighbor advertisement message is transmitted on a primary management connection identification (CID) of the subscriber station.

9. A method of operation of a base station to facilitate path selection in a multihop network for a subscriber station as claimed in claim 7, wherein the path link metric comprises one or more metrics selected from a group of metrics comprising a path cost, a hop count, a radio frequency a link quality, a neighborhood congestion, and a link congestion.

10. A method of operation of a base station to facilitate path selection in a multihop network for a subscriber station as claimed in claim 7, further comprising:
scheduling a plurality of scanning opportunities for the subscriber station by ordering the plurality of neighbor stations in an ascending order of path metrics.

11. A method of operation of a base station to facilitate path selection in a multihop network for a subscriber station as claimed in claim 10, further comprising:
scheduling one or more of the plurality of neighbor stations with the best path metric first when scheduling constraints prevent the including of all of the plurality of neighbor stations in the list of neighbors.

12. A method to facilitate path selection in a multihop network comprising:
initiating a subscriber station handoff;
receiving by a base station a path metric associated with each of a plurality of stations neighboring to the subscriber station;
comparing each of the path metrics with a current path metric; and
transmitting a path selection recommendation from the base station to the subscriber station when one of the compared path metrics is better than the current path metric.

13. A method to facilitate path selection in a multihop network as claimed in claim 12 wherein the initiating step comprises initiating the subscriber station handoff by a base station.

14. A method to facilitate path selection in a multihop network as claimed in claim 13 wherein the initiating step further comprises at the base station:
determining an end-to-end path metric to the subscriber station has dropped below a path metric to a best neighbor by a threshold value; and
in response, initiating the subscriber station handoff.

15. A method to facilitate path selection in a multihop network as claimed in claim 12 wherein the initiating step comprises initiating the subscriber station handoff by the subscriber station.

16. A method to facilitate path selection in a multihop network as claimed in claim 15 wherein the initiating step further comprises at the subscriber station:
determining a need to handoff based on a one-hop link characteristic; and
requesting permission from the base station to scan one or more neighbors.

17. A method to facilitate path selection in a multihop network as claimed in claim 12, further comprising after the initiating step:
establishing an agreement between the base station and the subscriber station for the subscriber station to scan each of the plurality of stations neighboring to the subscriber station.

18. A method to facilitate path selection in a multihop network as claimed by claim 17, further comprising prior to the receiving step:
scheduling by the base station one or more scanning opportunities for the subscriber station including ordering the scanning of the plurality of stations neighboring to the subscriber station by ascending path cost.

19. A method to facilitate path selection in a multihop network as claimed by claim 18, further comprising prior to the receiving step:
providing the subscriber station with one or more scanning instructions.

20. A method to facilitate path selection in a multihop network as claimed by claim 19, wherein the scanning instructions comprise:
instructing the subscriber station that one or more relay stations associated with one or more other base stations be scanned with association with network assistance.

21. A method to facilitate path selection in a multihop network as claimed by claim 20, wherein the scanning instructions comprise:
instructing the subscriber station that for relay stations associated with the base station and greater than a predetermined number of hops away, the subscriber station should scan with association with network assistance.

22. A method to facilitate path selection in a multihop network as claimed by claim 12, further comprising:
sending an association report message from the base station to the subscriber station including a ranging status as “abort” for one or more undesirable stations.
